(19) United States
(12) Patent Application Publication
(10) Pub. No.: US 2026/0058312 A1
(43) Pub. Date: Feb. 26, 2026

(54) INTEGRATED SEPARATOR-ANODE AND PREPARATION METHOD THEREOF

(71) Applicants: YI CHANG NANO NEW MATERIAL TECHNOLOGY (GUANGDONG) CO., LTD., Guangzhou City (CN); EVOPHANCIE BIOTECH LTD., New Taipei City (TW)

(72) Inventors: Qiong Wang, Guangzhou City (CN); Yang Huang, Guangzhou City (CN); Chao-Cheng Chen, New Taipei City (TW); Si Han Zheng, Guangzhou City (CN); De Zhi Zhang, Guangzhou City (CN)

(21) Appl. No.: 19/307,100

(22) Filed: Aug. 22, 2025

(30) Foreign Application Priority Data
Aug. 23, 2024 (CN) 202411173171.4

(51) Int. Cl. H01M 50/46; H01M 4/02; H01M 4/04; H01M 4/133; H01M 4/136; H01M 4/1393; H01M 4/1397; H01M 4/36; H01M 4/58; H01M 4/587; H01M 50/429

(52) U.S. Cl. CPC H01M 50/46; H01M 4/0402; H01M 4/0471; H01M 4/133; H01M 4/136; H01M 4/1393; H01M 4/1397; H01M 4/364; H01M 4/5815; H01M 4/587; H01M 50/4295; H01M 2004/023; H01M 2004/027

(57) ABSTRACT

The present disclosure provides an integrated separator-anode, including a bacterial cellulose membrane and an aqueous anode layer formed on a surface of the bacterial cellulose membrane by cross-linking via calcium ions. The aqueous anode layer is formed from a cross-linking reaction of a polymerized colloid, an alginate, and calcium ions in a presence of a sulfur-carbon nanotube composite, and the sulfur-carbon nanotube composite, the alginate, and the polymerized colloid have a concentration ratio of 1:0.06-0.33:0.16-1. The integrated separator-anode of the present disclosure is applicable for a lithium-sulfur battery which would exhibit a high discharge specific capacity, a high coulombic efficiency and a stable cycle performance.

### CROSS-REFERENCE TO RELATED APPLICATION

This Application claims the benefit of priority to Chinese Patent Application No. 202411173171.4, filed on Aug. 23, 2024, the entire contents of which are incorporated herein by reference.

### BACKGROUND

### 1. Technical Field

The present disclosure relates to a field of lithium-sulfur batteries, especially relates to an integrated separator-anode applied in the lithium-sulfur batteries and a method for preparing the same.

### 2. Description of Associated Art

Lithium ion batteries have been considered as secondary batteries with better overall performances in both industry and science since they were successfully produced in a commercial scale by Sony Corporation in 1991. Currently, lithium ion batteries have been broadly applied in various potable mobile terminals and electronic vehicles. Recently, the developmental purpose of “carbon neutrality” has made more requirements on scale storage and utilization of renewable energy source. Conventional lithium ion batteries fail to satisfy the requirements on high energy density and large capacity for power storage due to their limited theoretical capacity, it is therefore needed to seek a new electrode active system with a high specific energy and a high efficiency.

In contrast to traditional lithium ion batteries, a lithium-sulfur battery is formed by assembling a sulfur-containing electric conductor and a lithium metal as an anode and a cathode, respectively. The lithium-sulfur battery has very a high theoretical energy density (2567 Wh/kg) and a theoretical specific capacity (1675 mAh/g) which values are much higher than those of various lithium ion batteries currently commercialized. In addition, the elemental sulfur has a low environmental burden, does no harm to human and animals, and has a high abundance in the earth's crust. As a new generation of high-energy secondary battery with good developmental prospect, the lithium ion battery has received great attention from researchers. However, lithium-sulfur batteries should resolve several critical problems before commercially developed in a large scale. Among the problems, the “shuttle effect” caused by a dissolved polysulfide and lithium dendrite phenomenon resulted from uneven deposition of lithium ions have the most significant impact on capacity, stability, coulombic efficiency, etc. of a lithium-sulfur battery.

It is well known that biomass resource is abundant, low cost, easy to obtain, renewable, and environment friendly, which is the most important alternate to petroleum resource in the achievement of the purpose of “carbon neutrality” and therefore finds great values in development and applications. Bacterial cellulose, a typical biomass material, is generated by some bacteria via secondary metabolism. Bacterial cellulose has many advantages such as being rich in hydroxyl groups, ultrafine nanofibers, high mechanical strength, 3D macro pores, etc. (see, Huang et. al., (2014), Recent advances in bacterial cellulose, Cellulose, 21(1), 1-30) and is very suitable for use as a multi-functional separator material in a lithium-sulfur battery. For example, Yu et. al. (Cellulose-Based Porous Membrane for Suppressing Li Dendrite Formation in Lithium-Sulfur Battery, ACS Energy Letters, 2016) utilized a bacterial cellulose membrane as a separator material in a lithium-sulfur battery for the first time. Results of the research showed that the bacterial cellulose separator could promote the uniform deposition of lithium ions on the surface of lithium metal and prevent the formation of lithium dendrites. Compared to the commercialized Celgard separator, the bacterial cellulose separator exhibits better abilities in electrolyte solution absorption and holding, as well as excellent thermal stability. Using the properties of bacterial cellulose to improve the interface relationship between electrode and the separator, to inhibit diffuse of the polysulfide, and to reduce the puncture short circuit caused by lithium dendrites, remains a problem urgently to be solved in the art.

### SUMMARY

Aiming at the various technical shortages described above, the present disclosure provides an integrated separator-anode, comprising a bacterial cellulose membrane and an aqueous anode layer formed on a surface of the bacterial cellulose membrane by cross-linking, wherein the aqueous anode layer is formed from a cross-linking reaction of a polymerized colloid, an alginate, and calcium ions in a presence of a sulfur-carbon nanotube composite; wherein the sulfur-carbon nanotube composite, the alginate, and the polymerized colloid have a mass concentration ratio of 1:0.06-0.33:0.16-1.

In an embodiment, the aqueous anode layer comprises a sulfur-carbon nanotube composite and methacryloyl colloid as well as a colloid formed after the cross-linking of alginate via the calcium ions. The methacryloyl colloid can be a gelatin methacrylate (GelMA) or a hyaluronic acid methacrylate (HAMA).

The present disclosure also provides a method for preparing the integrated separator-anode of preceding embodiments, comprising the following steps: (1) mixing a sulfur-carbon nanotube composite with water to form an aqueous dispersion; (2) adding an alginate, a photopolymerizable material and a photopolymerization initiator to the aqueous dispersion and mixing to form an aqueous anode slurry; (3) coating the aqueous anode slurry on a surface of a frozen-dried bacterial cellulose membrane in a manner of blade coating, initiating a photopolymerization under an ultraviolet irradiation for the photopolymerizable material to form a polymerized colloid, thereby the aqueous anode slurry to is pre-gelated to form an aqueous anode layer; and (4) soaking the aqueous anode layer along with the bacterial cellulose membrane in a calcium ions-containing aqueous solution to perform a cross-linking reaction of the polymerized colloid, the alginate, and the calcium ions in the presence of the sulfur-carbon nanotube composite to form the integrated separator-anode.

In an embodiment, a mass concentration of the sulfur-carbon nanotube composite can be 20-40 mg/mL, for example, but not limited to, 20, 21, 22, 23, 24, 25, 26, 27, 28, 29, 30, 31, 32, 33, 34, 35, 36, 37, 38, 39, or 40 mg/mL, preferably 30 mg/mL.

In an embodiment, a mass concentration of the alginate can be 2-10 mg/mL, for example, but not limited to, 2, 2.1, 2.2, 2.3, 2.4, 2.5, 2.6, 2.7, 2.8, 2.9, 3, 4, 5, 6, 7, 8, 9, or 10 mg/mL.

In an embodiment, a mass concentration of the polymerized colloid can be 5-30 mg/mL, for example, but not limited to, 5, 6, 7, 8, 9, 10, 11, 12, 13, 14, 15, 16, 17, 18, 19, 20, 21, 22, 23, 24, 25, 26, 27, 28, 29, or 30 mg/mL.

In an embodiment, a mass ratio of the sulfur and the carbon nanotube can be 1:0.5-1.5. The mass ratio of the sulfur and the carbon nanotube can be, for example, but not limited to, 1:0.5, 1:0.6, 1:0.7, 1:0.8, 1:0.9, 1:1, 1:1.1, 1:1.2, 1:1.3, 1:1.4, or 1:1.5.

In an embodiment, a sulfur load per unit area of the aqueous anode layer can be 1-2 mg/cm². The sulfur load per unit area can be, for example, but not limited to 1.1, 1.2, 1.3, 1.4, 1.5, 1.6, 1.7, 1.8, 1.9, or 2.0 mg/cm².

In an embodiment, the sulfur can be an elemental sulfur. In an embodiment, the elemental sulfur can be a sublimed sulfur or a high-purity sulfur.

In an embodiment, the carbon nanotube can be a multi-walled carbon nanotube. In an embodiment, the multi-walled carbon nanotube can be a carboxylated multi-walled carbon nanotube, e.g., carboxylated multi-walled carbon nanotube with a purity of greater than 95%.

In an embodiment, the sulfur-carbon nanotube composite in step (1) is prepared by: grinding the sulfur and the carbon nanotube in a mortar for 10-30 minutes to obtain powders; placing the powders in a closed autoclave and subjecting the powders to a thermal treatment at 140-170° C. for 11-13 hours; cooling the thermally treated powders to 20-35° C. to yield the sulfur-carbon nanotube composite; and mixing the sulfur-carbon nanotube composite into water by ultrasonic dispersing to form the aqueous dispersion. In the embodiment, the mortar can be an agate mortar; a grinding time can be, for example, but not limited to 10, 11, 12, 13, 14, 15, 16, 17, 19, 20, 21, 22, 23, 24, 25, 26, 27, 28, 29, or 30 minutes; a temperature for placing the autoclave in a thermostat is for example, but not limited to 140, 145, 150, 155, 160, 165, or 170° C.; a time for placing the autoclave in the thermostat can be, for example, but not limited to 11, 11.5, 12, 12.5, or 13 hours.

In an embodiment, the sulfur-carbon nanotube composite in step (1) has a mass concentration of 20-40 mg/mL, the alginate of the aqueous anode slurry in step (3) has a mass concentration of 2-10 mg/mL, and the polymerized colloid has a mass concentration of 5-30 mg/mL.

In an embodiment, the blade coating in step (3) is: coating the aqueous slurry on the surface of the bacterial cellulose membrane using a blade at a moving rate of 4-6 mm/s, and a distance between the blade and the bacterial cellulose membrane is 140-160 m. In the embodiment, the distance can be, for example, but not limited to, 140 141, 142, 143, 144, 145, 146, 147, 148, 149, 150, 151, 152, 153, 154, 155, 156, 157, 158, 159, or 160 m; the moving rate can be, for example, but not limited to 4, 4.2, 4.4, 4.6, 4.8, 5, 5.2, 5.4, 5.6, 5.8, or 6 mm/s.

In an embodiment, the polymerized colloid can be a colloid obtained from a photopolymerizable material of a double bond-modified gelatin by photopolymerization. In the embodiment, the double bond-modified gelatin is gelatin methacrylate (GelMA) or hyaluronic acid methacrylate (HAMA), preferably GelMA.

In an embodiment, the photopolymerization is performed in a presence of a photopolymerization initiator. The photopolymerization initiator can be an ultraviolet photoinitiator. In the embodiment, the ultraviolet photoinitiator is a lithium phenyl(2,4,6-trimethylbenzoyl)phosphinate (LAP).

In an embodiment, the photopolymerization is performed in a presence of water. The water is preferably deionized water.

In an embodiment, the alginate is at least one selected from the group consisting of sodium alginate, potassium alginate, magnesium alginate, and ammonium alginate.

In an embodiment, the ultraviolet irradiation in step (3) is: radiating the coated aqueous anode slurry with an ultraviolet at a wavelength of 360-370 nm for 3-10 minutes. In the embodiment, the ultraviolet has the wavelength of, for example, but not limited to, 360, 361, 362, 363, 364, 365, 366, 367, 368, 369, or 370 nm; a time of the ultraviolet irradiation can be, for example, but not limited to, 3, 3.5, 4, 4.5, 5, 5.5, 6, 6.5, 7, 7.5, 8, 8.5, 9, 9.5, or 10 minutes.

In an embodiment, the calcium ions-containing aqueous solution in step (4) is a solution prepared by dissolving at least one calcium-containing material selected from calcium chloride, calcium lactate and calcium hydroxide in water, and the alginate and the calcium-containing material have a concentration ratio of 1:1-2. In an embodiment, the calcium-containing material is preferably the calcium chloride.

In an embodiment, the calcium-containing material is added at an amount of 2-20 mg/mL. In an embodiment, the calcium-containing material has a mass concentration of, for example, but not limited to, 2, 3, 4, 5, 6, 7, 8, 9, 10, 11, 12, 13, 14, 15, 16, 17, 18, 19, or 20 mg/mL.

In an embodiment, the cross-linking reaction in step (4) is: soaking the aqueous anode layer along with the bacterial cellulose membrane in the calcium ions-containing aqueous solution at 20-35° C. for 3-5 hours to perform the cross-linking reaction of the polymerized colloid, the alginate, and the calcium ions in the presence of the sulfur-carbon nanotube composite, thereby forming the integrated separator-anode. In the embodiment, a soaking time can be, for example, but not limited to, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, or 5 hours.

In an embodiment, the mass concentration of the sulfur-carbon nanotube composite can be 20-40 mg/mL, the mass concentration of the alginate can be 2-10 mg/mL, the mass concentration of the photopolymerizable materials can be 5-30 mg/mL, the photopolymerization initiator can be added at an amount of 10 wt % based on an amount of the photopolymerizable materials, and the mass concentration of the calcium ions-containing aqueous solution can be 2-20 mg/mL. With these concentration ranges, it is beneficial to achieve a proper pre-gelation or cross-linking and a further gelation.

Compared to the prior art, the present disclosure has beneficial effects of: (1) the present disclosure uses a green, renewable, degradable and natural biomass, bacterial cellulose as a separator base to effectively enhance the mechanical strength and thermal stability of the separator of battery; (2) the bacterial cellulose employed in the present disclosure is rich in macroporous network structure with a large amount of hydroxyl groups on the surface of the cellulose, a fast delivery of lithium ions can be ensured, while the shuttle effect of the polysulfide can be effectively reduced; (3) only water is used as a dispersant and solvent during the preparation and coating of the aqueous anode slurry without use of any other organic solvent, and thus there are advantages in both safety and environment protection compared to the traditional electrodes and preparation thereof; (4) the design of integrated separator-anode structure has significantly positive effects on the enhancement of battery flexibility and the reduction of ions/electrons interface delivery; and (5) by using the integrated bacterial cellulose separator-anode structure to assemble a lithium-sulfur battery, the battery exhibits high specific capacity, high coulombic efficiency, and stable cycle performance.

### BRIEF DESCRIPTION OF THE DRAWINGS

The embodiments of the present disclosure will be illustrated by exemplary reference figures:

FIG. 1 shows a flow chart of preparation of the integrated separator-anode structure of the present disclosure.

### DETAILED DESCRIPTION OF THE PREFERRED EMBODIMENTS

The embodiments of the present disclosure will be illustrated by the following embodiments, and those skilled in the art can easily understand the advantages and benefits of the present disclosure from the content described in this specification. The present disclosure can be practiced or applied by other different implementations, and different modifications and alternations can be made to the details of the present specification based on different views and applications without departing from the spirit described in the present disclosure. Furthermore, all of the ranges and values mentioned herein are inclusive and combinable. Any numerical value or point, e.g., any integer, falling into a range described herein can be used as a lower or an upper limit to derive a subrange.

Specifically, the present disclosure provides an integrated structural design of a separator-anode, and mainly relates to an integrated composite structure of a bacterial cellulose separator-anode based on an aqueous system, and the composite structure can be applied in a lithium-sulfur battery.

The naturally formed 3D continuous structure of bacterial cellulose can be used as a flexible separator of a battery, in which the abundant network porous structure inside the bacterial cellulose provides many channels for delivery of lithium ions. Hydroxyl groups on the surface of the bacterial cellulose is not only beneficial to enhance wettability of electrolyte solution but also capable of inhibiting the “shuttle effect” of dissolved polysulfide, and the good mechanical strength of the bacterial cellulose provides a positive effect on the reduction of puncture short circuit caused by lithium dendrites.

Since the bacterial cellulose has abundant hydroxyl groups beneficial for inhibiting shuttle of polysulfide, a high mechanical strength can resist the puncture effects caused by lithium dendrites, and a high porosity is advantageous for a fast delivery of lithium ions, the present disclosure provides a lithium-sulfur battery having an integrated separator-anode structure design by using the bacterial cellulose having high porosity, high mechanical strength, and a nanofiber network structure described above as a supporting base that is further coated with an alginate-based aqueous anode slurry. After drying completely, a strong interfacial interaction is formed between the alginate-based aqueous slurry and the bacterial cellulose separator, which is beneficial to the stabilization of electrode structure and interfacial delivery of ions.

Therefore, the bacterial cellulose separator-anode integrated composite structure on an aqueous system basis provided in the present disclosure and the preparation method thereof, use bacterial cellulose as a multi-functional separator of a lithium-sulfur battery, and uses the surface affinity interaction between an alginate-based aqueous anode slurry and the cellulose to achieve the integrated separator-anode design, allowing the bacterial cellulose separator-anode integrated structure constructed on an aqueous system basis to significantly enhance the interfacial compatibility between the electrode and the separator, to reduce the resistance for interfacial transfer of ions and electrons, and thus to minimize the resistance for interfacial delivery of ions and electrons. In addition, the lithium-sulfur battery assembled with the integrated separator-anode exhibits high specific capacity, high coulombic efficiency, and stable cycle performance.

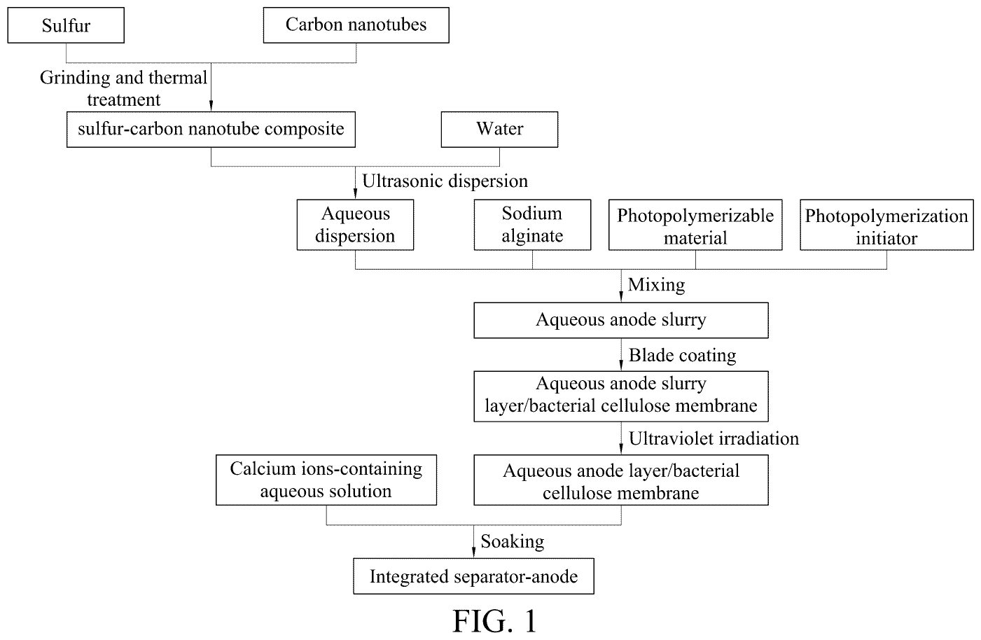

As shown in FIG. 1, the present disclosure provides a preparation method of the integrated separator-anode described above, comprising: grinding sulfur and carbon nanotube in a mortar for 10-30 minutes to give powders, placing the powders in a closed autoclave, performing a thermal treatment at 140-170° C. for 11-13 hours, cooling to 20-35° C. to yield a sulfur-carbon nanotube composite, mixing the sulfur-carbon nanotube composite in water by ultrasonic dispersion to form an aqueous dispersion; adding an alginate, a photopolymerizable material and a photopolymerization initiator to the aqueous dispersion and mixing thoroughly to form an aqueous anode slurry; next, coating the aqueous anode slurry on the surface of a frozen-dried bacterial cellulose membrane by a blade coating process with a blade at a moving rate of 4-6 mm/s, and a distance of 140-160 m between the blade and the bacterial cellulose membrane, then radiating with the ultraviolet at a wavelength of 360-370 nm for 3-10 minutes to initiate a photopolymerization, allowing the photopolymerizable material in the aqueous anode slurry to form a polymerized carboxyl-containing colloid, subjecting the aqueous anode slurry to a cross-linking reaction via the carboxyl groups and pre-gelation, thereby forming an aqueous anode layer; and finally, soaking the aqueous anode layer along with the bacterial cellulose membrane in a calcium ions-containing aqueous solution at 20-35° C. for 3-5 hours to perform a cross-linking reaction of the polymerized colloid, the alginate, and the calcium ions in the presence of the sulfur-carbon nanotube composite, and forming the integrated separator-anode after thoroughly washing and freeze-drying.

### EXAMPLES

The present disclosure will be illustrated in detail by specific Preparation Examples below which should not to be considered to limit the scope of the present disclosure.

### Preparation Example 1 (Integrated Separator-Anode)

Sublimed sulfur (S) and carboxylated carbon nanotubes (CNTs) with a purity of 99.5% (Jiangsu Xfnano Materials Tech Co., Ltd.) at the same mass were ground in an agate mortar for 20 minutes to give powders which were placed in an autoclave. The autoclave was completely closed and placed in a thermostat of 155° C. for 12 hours. After cooling, a sulfur-carbon nanotube composite (S/CNTs) was yielded.

The S/CNTs and deionized water were subjected to ultrasonic dispersion for 30 minutes to give an aqueous dispersion, and then sodium alginate (Shanghai Macklin Biochemical Technology Co., Ltd.), GelMA (Suzhou Intelligent Manufacturing Research Institute) and LAP (Suzhou Intelligent Manufacturing Research Institute) were dissolved in the aqueous dispersion simultaneously to yield an aqueous anode slurry.

A frozen-dried bacterial cellulose membrane was provided, and the aqueous anode slurry was coated on a surface of the bacterial cellulose membrane uniformly by a blade coating process using a blade at a moving rate of 5 mm/s with a distance of 150 m between the blade and the bacterial cellulose. Afterwards, an ultraviolet irradiation was performed at a wavelength of 365 nm for 5 minutes to initiate a photo-crosslinking reaction of GelMA to form a 3D cross-linked network structure, and the aqueous anode slurry was pre-gelated to yield a semi-product containing a pre-gelated aqueous anode layer and the bacterial cellulose membrane as a substrate.

The semi-product was soaked in a calcium chloride (CaCl₂) aqueous solution for 4 hours, sodium alginate was significantly cross-linked via the calcium ions and pre-gelated to yield a composite, and the composite was washed thoroughly and frozen-dried again to yield an integrated separator-anode product.

According to the method of Preparation Example 1 described above, the separator-anode products of Examples 1-7 and Comparative Examples 1 and 2 were respectively prepared at the mass concentrations in Table 1 below.

### Preparation Example 2 (Lithium-Sulfur Battery)

A button battery model CR2032 was selected, in which, the anode material was a sulfur-carbon nanotube composite, the cathode material was lithium metal sheet, the separator material was Celgard 2250, and the electrolyte solution had 1 M lithium bis-trifluoromethylsulfonyl imide (LiTFSI) as an electrolyte, 1 wt % of lithium nitrate (LiNO₃) as an additive, and the mixture of ethylene glycol dimethyl ether (DME) and 1,3-dioxolane (DOL) at a volume ratio of 1:1 as a solvent.

According to the battery model selected in the Preparation Example 2 described above, the integrated separator-anode product described above was assembled in the battery to replace the anode and the separator to obtain the lithium-sulfur battery samples of Examples 1-7 and Comparative Examples 1 and 2.

### Experimental Example: Electrochemical Test and Analysis

Constant current charging/discharging tests were carried out on the electrodes of the lithium-sulfur battery samples of Examples 1-7 and Comparative Examples 1 and 2 using a battery detection device (LAND CT-2001A, Wuhan Land Electronics Co., Ltd.) and a current density of 800 mA/g, and the results of discharging specific capacities and average coulombic efficiencies were recorded in Table 1 below.

TABLE 1

| | | | | | | | | Comparative | |
|---|---|---|---|---|---|---|---|---|---|
| | Example | | | | | | | Example | |
| | 1 | 2 | 3 | 4 | 5 | 6 | 7 | 1 | 2 |
| S/CNTs (mg/mL) | 30 | 30 | 30 | 30 | 30 | 30 | 30 | 30 | 30 |
| Sodium alginate | 2 | 5 | 5 | 5 | 5 | 10 | 10 | 5 | — |
| (mg/mL) | | | | | | | | | |
| GelMA (mg/mL) | 5 | 10 | 15 | 15 | 30 | 15 | 30 | — | 15 |
| LAP (mg/mL) | 0.5 | 1 | 1.5 | 1.5 | 3 | 1.5 | 3 | — | 1.5 |
| CaCl₂ (mg/mL) | 2 | 5 | 10 | 20 | 10 | 10 | 10 | 10 | — |
| Pre-gelation | ◯ | ◯ | ◯ | ◯ | ◯ | ◯ | ◯ | X | ◯ |
| Cross-linking | ◯ | ◯ | ◯ | ◯ | ◯ | ◯ | ◯ | ◯ | X |
| and gelation | | | | | | | | | |
| Sulfur load per | 1.5 | 1.5 | 1.5 | 1.5 | 1.5 | 1.5 | 1.5 | 1.5 | 1.5 |
| unit area (mg/cm²) | | | | | | | | | |
| Specific capacity | 882 | 993 | 1284 | 1242 | 831 | 997 | 787 | 1098 | 1049 |
| at the first | | | | | | | | | |
| discharging | | | | | | | | | |
| (mAh/g) | | | | | | | | | |
| Specific capacity | 672 | 722 | 943 | 938 | 613 | 768 | 538 | 823 | 667 |
| at 100th | | | | | | | | | |
| discharging | | | | | | | | | |
| (mAh/g) | | | | | | | | | |
| Specific capacity | 546 | 689 | 901 | 896 | 552 | 737 | 467 | 748 | 476 |
| at 200th | | | | | | | | | |
| discharging | | | | | | | | | |
| (mAh/g) | | | | | | | | | |
| Specific capacity | 414 | 641 | 872 | 867 | 524 | 688 | 448 | 706 | 311 |
| at 300th | | | | | | | | | |
| discharging | | | | | | | | | |
| (mAh/g) | | | | | | | | | |
| Average coulombic | 94.2 | 98.4 | 99.2 | 98.9 | 97.1 | 98.5 | 95.6 | 98.4 | 92.8 |
| efficienc (%) | | | | | | | | | |

The results of Example 1, Example 2 and Example 3 in Table 1 showed that the batteries had a more serious capacity fading when the alginate and the photopolymerizable material (GelMA) were added at lower amounts. The main reason was that the 3D network structure constructed by polymer interpenetration inside the electrode had not yet formed, and the micro nano structure of the electrode was not stable enough when the amounts of the above-mentioned polymer were too small.

The results of Example 3 and Example 4 in Table 1 showed that the electrochemical performances of the batteries could not be further enhanced by only increasing the concentration of the CaCl₂ aqueous solution for cross-linking via calcium ions without changing other conditions. It was also demonstrated that the cross-linking via calcium ions could be completely carried out by soaking in the CaCl₂ aqueous solution with a mass concentration of 10 mg/m for 4 hours, and it was not necessary to further increase the concentration of the CaCl₂ aqueous solution.

The results of Example 3, Example 5 and Example 6 in Table 1 illustrated that the discharge specific capacity, cycle stability and coulombic efficiency of the batteries were significantly affected when the alginate and the photopolymerizable material (GelMA) were added at higher amounts, with the increase in added amount of GelMA had a more significant influence on the battery performances. Since both the alginate and GelMA were materials without electric conductivity, and excessive incorporation of these components may reduce the overall electronic conductivity of the electrode, thereby adversely affecting its electrochemical performance. As shown in Example 7 of Table 1, the electrochemical performance of the battery was significantly compromised when the proportion of non-conductive components became excessively high.

The results of Example 3, Comparative Example 1 and Comparative Example 2 in Table 1 showed that although the batteries had higher initial discharging capacities without performing pre-gelation under ultraviolet irradiation or without performing gelation of alginate via calcium ions, the batteries had performances declined very seriously during subsequent cycles, which was mainly owing to the fact that a stable micro-nano structure of electrode relied on an interpenetrating polymer network structure. It can be seen from the data of Comparative Example 2 that the alginate functioned more critically on the formation of a stable electrode structure.

In conclusion, the integrated separator-anode of the present disclosure has the bacterial cellulose membrane as the supporting base, and the aqueous anode layer with the alginate is further formed on the surface of the bacterial cellulose membrane by cross-linking. Therefore, when the integrated separator-anode is applied in lithium-sulfur batteries the discharge specific capacity, the coulombic efficiency and the cycle performances of batteries can be effectively enhanced. In addition, compared to a conventional electrode, the integrated separator-anode of the present disclosure employed only water during the preparation process without utilization of any other organic solvent, which had advantages in both safety and environment protection, and therefore application prospects.

The examples described above are provided for the purpose of illustration only and not for limiting the present disclosure. Modifications and alternations can be made to the examples described above by one skilled in the art without departing from the spirit and scope of the present disclosure. Therefore, the claimed range of the present disclosure is defined by the claims attached, and should be encompassed in the technical solutions of the present disclosure as long as it has no impact on the results and implementation of the present disclosure.

What is claimed is:

1. An integrated separator-anode, comprising:
a bacterial cellulose membrane; and
an aqueous anode layer formed on a surface of the bacterial cellulose membrane, wherein the aqueous anode layer is formed from a cross-linking reaction of a polymerized colloid, an alginate, and calcium ions in a presence of a sulfur-carbon nanotube composite;
wherein the sulfur-carbon nanotube composite, the alginate, and the polymerized colloid have a mass concentration ratio of 1:0.06-0.33:0.16-1.

2. The integrated separator-anode of claim 1, wherein the sulfur-carbon nanotube composite has a mass concentration of 20-40 mg/mL, the alginate has a mass concentration of 2-10 mg/mL, and the polymerized colloid has a mass concentration of 5-30 mg/mL.

3. The integrated separator-anode of claim 1, wherein the sulfur and the carbon nanotube have a mass ratio of 1:0.5-1.5.

4. The integrated separator-anode of claim 1, wherein the aqueous anode layer has a sulfur load per unit area of 1-2 mg/cm².

5. The integrated separator-anode of claim 1, wherein the sulfur is an elemental sulfur, the carbon nanotube is a multi-walled carbon nanotube, the polymerized colloid is one obtained by photopolymerization of a double bond-modified gelatin, and the photopolymerization is performed in a presence of a photopolymerization initiator.

6. The integrated separator-anode of claim 5, wherein the sulfur is a sublimed sulfur or a high-purity sulfur, the carbon nanotube is a carboxylated multi-wall carbon nanotube, the double bond-modified gelatin is a gelatin methacrylate (GelMA) or a hyaluronic acid methacrylate (HAMA), and the photopolymerization initiator is a lithium phenyl(2,4,6-trimethylbenzoyl) phosphonate (LAP).

7. The integrated separator-anode of claim 1, wherein the alginate is at least one selected from the group consisting of sodium alginate, potassium alginate, magnesium alginate, and ammonium alginate.

8. A method for preparing the integrated separator-anode of claim 1, wherein the method comprises the following steps:
(1) mixing a sulfur-carbon nanotube composite with water to form an aqueous dispersion;
(2) adding an alginate, a photopolymerizable material and a photopolymerization initiator into the aqueous dispersion, and mixing to form an aqueous anode slurry;
(3) coating the aqueous anode slurry on a surface of a frozen-dried bacterial cellulose membrane by a blade coating process, performing a photopolymerization under an ultraviolet irradiation for the photopolymerizable material to form a polymerized colloid, thereby the aqueous anode slurry is pre-gelated, so as to form an aqueous anode layer; and
(4) soaking the aqueous anode layer along with the bacterial cellulose membrane in a calcium ions-containing aqueous solution to perform a cross-linking reaction of the polymerized colloid, the alginate, and the calcium ions in a presence of the sulfur-carbon nanotube composite, thereby forming the integrated separator-anode.

9. The method of claim 8, wherein the sulfur-carbon nanotube composite in step (1) has a mass concentration of 20-40 mg/mL, the alginate of the aqueous anode slurry in step (3) has a mass concentration of 2-10 mg/mL, and the polymerized colloid has a mass concentration of 5-30 mg/mL.

10. The method of claim 8, wherein the sulfur and the carbon nanotube have a mass ratio of 1:0.5-1.5.

11. The method of claim 8, wherein the sulfur is an elemental sulfur, the carbon nanotube is a multi-walled carbon nanotube, and the polymerized colloid is one obtained from a double bond-modified gelatin by photopolymerization.

12. The method of claim 11, wherein the sulfur is a sublimed sulfur or a high-purity sulfur, the carbon nanotube is a carboxylated multi-wall carbon nanotube, the double bond-modified gelatin is a gelatin methacrylate (GelMA) or a hyaluronic acid methacrylate (HAMA), and the photopolymerization initiator is a lithium phenyl(2,4,6-trimethylbenzoyl)phosphinate (LAP).

13. The method of claim 8, wherein the alginate is at least one selected from the group consisting of sodium alginate, potassium alginate, magnesium alginate, and ammonium alginate.

14. The method of claim 8, wherein the aqueous solution in step (1) is prepared by: grinding the sulfur and the carbon nanotube in a mortar for 10-30 minutes to obtain powders; placing the powders in a closed autoclave and subjecting the powders to a thermal treatment at 140-170° C. for 11-13 hours; cooling the thermally treated powders to 20-35° C. to yield the sulfur-carbon nanotube composite; and mixing the sulfur-carbon nanotube composite into water by ultrasonic dispersing to form the aqueous dispersion.

15. The method of claim 8, wherein the blade coating in step (3) is: coating the aqueous slurry on the surface of the bacterial cellulose membrane using a blade at a moving rate of 4-6 mm/s, and a distance between the blade and the bacterial cellulose membrane is 140-160 m.

16. The method of claim 8, wherein the ultraviolet irradiation in step (3) is: irradiating the coated aqueous anode slurry with an ultraviolet at a wavelength of 360-370 nm for 3-10 minutes.

17. The method of claim 8, wherein the calcium ions-containing aqueous solution in step (4) is a solution prepared by dissolving at least one calcium-containing material selected from calcium chloride, calcium lactate and calcium hydroxide in water, and the alginate and the calcium-containing material have a concentration ratio of 1:1-2.

18. The method of claim 17, wherein the calcium-containing material is added at an amount of 2-20 mg/mL.

19. The method of claim 8, wherein the cross-linking reaction in step (4) is: soaking the aqueous anode layer along with the bacterial cellulose membrane in the calcium ions-containing aqueous solution at 20-35° C. for 3-5 hours to perform the cross-linking reaction of the polymerized colloid, the alginate, and the calcium ions in the presence of the sulfur-carbon nanotube composite, thereby forming the integrated separator-anode.
